(19) United States
(12) Patent Application Publication
(10) Pub. No.: US 2026/0356057 A1
(43) Pub. Date: Nov. 12, 2026

(54) Elastomeric Tooling Bladder and Its Manufacturing Method

(71) Applicant: Short Brothers PLC, Antrim (GB)

(72) Inventors: Oran WALSH, Antrim (GB); Mark Anthony BRANIFF, Antrim (GB); Sam WILSON, Antrim (GB)

(21) Appl. No.: 19/139,744

(22) PCT Filed: Dec. 18, 2023
(86) PCT No.: PCT/GB2023/053292

§ 371 Date: Jun. 16, 2025

(30) Foreign Application Priority Data
Dec. 16, 2022 (GB) 2219112.6

(51) Int. Cl. B29C 70/54

(52) U.S. Cl. CPC B29C 70/544

(57) ABSTRACT

A method of manufacturing an elastomeric tooling bladder (210, 310) is described. The method comprises: forming a first part (511) comprising a laminated composite material in a first mould (502), forming a second part (513) comprising a laminated material structure in a second mould (503), wherein the laminated composite material comprises a plurality of layers, and wherein at least one layer comprises a reinforced elastomer material; and joining the first part and the second part to form a bladder body defining a cavity (544), wherein the bladder body is configured to accommodate thermal expansion and contraction. Also described is an elastomeric tooling bladder.

### TECHNICAL FIELD

Apparatus and methods for forming composite components. In particular, the present disclosure relates to an elastomeric tooling bladder and methods of manufacture thereof.

### BACKGROUND OF THE INVENTION

In the manufacture of composite parts, such as body parts in the aerospace and other related industries, moulds are typically used for fabricating composite parts using a resin. The application of the resin typically takes place under highly controlled conditions, such as of temperature, pressure, etc. Conventionally, such composite parts are manufactured using Resin Transfer Moulding (RTM,) or other closed mould applications with tooling in an autoclave. Accordingly, high-precision resin composite components can be fabricated.

Composite materials such as carbon fibre composite and fibreglass composite are formed from reinforcement material (typically fibrous) impregnated with a matrix material. Typically, multiple plies or layers of a fabric reinforcement material are impregnated with and reinforce a polymer matrix. For example, a carbon fibre fabric is formed by carbonizing a synthetic polymer fabric material and may be provided in the form of woven fabric, non-woven fabric or may consist of unidirectional fibres. Similar composites may be formed using alternative fibrous materials, such as glasses or synthetic polymers (e.g. aramid), or combinations of such materials. Composites may also be formed by mixing or dispersing relatively short strands or fibrils of a fibre material, such as carbon fibre or a glass fibre, within a polymer matrix to form a mouldable or injectable composite material.

A primary issue with existing RTM and other closed mould application is an inherent difficulty in designing and manufacturing internal tooling accurately enough to consider the totality of machining tolerances, i.e. to ensure all the tooling will fit properly in the desired cavity. Additionally, if the internal tooling is manufactured using metallic material, considerations must be given to thermal expansion, and the tools need to be compensated accordingly.

FIG. 1 shows an example of typical closed mould application 100, utilising solid metallic tooling 110. Each piece of the machined tooling comes with its own manufacturing tolerances (+/−). In one undesirable scenario, all of the internal mandrels 110 could be manufactured in a +ve condition and the outer mould tooling 115 is manufactured in a −ve tolerance condition.

This will either cause the component spar webs to be manufactured overly compacted (high fiber volume ratio, Vf, i.e. thin)I or the cause the component spar webs to not fit into the mould when combined with potential component bulk factor. In another scenario, the opposite can occur, wherein all the internal mandrels 110 are manufactured in a −ve condition and the outer tooling 115 is manufactured in a +ve tolerance condition. This will result in the component spar webs to be under compacted (low fiber volume ratio, Vf, i.e. thick), and the internal mandrels 110 will have too much movement and not seat correctly in place. Additionally, all metallic components (mould tooling 115, and internal mandrels 110) need to be scaled correctly to be at the correct size at the resin cure temperature.

A typical civil air transport wing consists of a main torsion box of ribs and spars with articulated control surfaces forming the trailing edge structure. This arrangement of control surfaces experiences considerable loads during certain critical flight phases. As a consequence these structures are complex in terms of stiffness/load introduction requirements and comprise intricate design features.

The use of bladders as tooling parts in the formation of composite parts is known. However, issues exist with these bladders. For example, existing bladders can be expensive, can suffer vacuum integrity issues, may require reforming processes after use to form a composite part, and may be overly flexible for a desired application.

It may be an object of one or more aspects, examples, embodiments, or claims of the present disclosure to at least mitigate or ameliorate one or more problems associated with existing tooling bladders and the methods of manufacture thereof, such as those described herein or elsewhere.

### SUMMARY OF THE INVENTION

According to an aspect of the present disclosure, there is provided a method of manufacturing an elastomeric tooling bladder. The method comprises: forming a first part comprising a laminated composite material in a first mould, forming a second part comprising a laminated material structure in a second mould, wherein the laminated composite material comprises a plurality of layers, and wherein at least one layer comprises a reinforced elastomer material; and, the method comprises joining the first part and the second part to form a bladder body defining a cavity, wherein the bladder body is configured to accommodate thermal expansion and contraction.

According to the present disclosure, there is provided a method which advantageously allows for the production of bespoke elastomeric tooling bladders. This allows for the properties of the elastomeric tooling bladders to be tailored according to the elastomeric tooling bladder's intended application, for use in the manufacture of a composite part.

The elastomeric tooling bladders made according to the methods of the present disclosure comprise at least one layer of a reinforced elastomeric material and as such, may be considered to be semi-flexible. However, unlike known elastomeric tooling bladders, the degree of flexibility of the elastomeric tooling bladders of the present disclosure can be carefully selected to impart a desired flexibility required for the intended application of the elastomeric tooling bladder. For example, the elastomeric tooling bladders of the present disclosure are intended to be used a “soft tooling” in the manufacture of composite parts. The elastomeric bladders are configured to accommodate thermal expansion and contraction which may occur during the manufacture of a composite part, whilst maintaining geometrical integrity (i.e. overall shape) by virtue of the reinforced elastomer layer.

Elastomeric tooling bladders manufactured according to the methods of the present disclosure may be configured to act as an ‘expansion joint’ between tightly controlled hard tooling and may alleviate tolerance stack-ups. The elastomeric tooling bladders of the present disclosure may also aid in air extraction and resin flow distribution across a component part during manufacture of the component part. This may increase wet out whilst reducing the infusion time for the manufacture of a component part.

The elastomeric tooling bladders manufactured according to the methods of the present disclosure are configured to enact a consolidation force on a component within a component tooling assembly by way of a pressure differential. The consolidation force may be generated in atmospheric conditions or in an autoclave. The elastomeric tooling bladders may be configured to perform a consolidation pressure at, for example, at about 20 °C to about 205 °C. The elastomeric tooling bladders of the present disclosure may be configured to be autoclave capable, i.e. able to withstand temperatures of about 180 °C without degradation.

The term “semi-flexible” herein refers to a degree to flexibility that allows the elastomeric tooling bladder to deflect to some degree to accommodate thermal expansion and contraction of the elastomeric tooling bladder and/or adjacent components, under the conditions encountered in use (typically over a temperature range from around ambient temperature to around 200-210 Celsius depending on manufacturing conditions), but having sufficient rigidity to maintain the general shape and configuration of the elastomeric tooling bladder, under its own weight. That is to say, a flexible tooling bladder may in use be draped over and/or peeled from a layup or part as the case may be, whereas a semi-flexible elastomeric bladder can be positioned or removed as a whole. In comparison to a hard tooling surface or hard tooling, the degree of flexibility afforded by a semi-flexible elastomeric tooling bladder eases separation of parts from the mould (that might otherwise be retained by suction against a hard surface such as Invar). In turn, the risk of surface damage upon release or separation of composite parts is reduced.

The method may comprise selecting a desired degree of flexibility for the bladder body, and wherein the forming of the first part and the second part comprises selecting the material for the plurality of layers, selecting a number of the layers, and layering the plurality of layers in a desired order, and/or at a desired location to impart the desired flexibility to the body. The method may also comprise selecting a thickness for a layer.

Accordingly, the degree of flexibility of the elastomeric tooling bladder can be carefully controlled and manufactured to ensure the desired performance in the intended application of the elastomeric tooling bladder.

The term “layer” is intended to encompass a layer of material covering substantially all or all of a moulding surface (a “full layer”) of the mould or part surface, or a portion of the mould or part surface (a partial layer). The term layer is intended to encompass full layers or partial layer having a uniform thickness or a varied thickness across the surface area of the layer. For example, a single layer of reinforcement material may comprise a thickness of between about 0.254 mm to about 12.7 mm, for example, about 0.279 mm. For example, a single layer of unreinforced elastomer material may comprise a thickness of between about 0.50 mm to about 2.00 mm, or 0.80 mm to about 1.60 mm. For example, a single layer of reinforced elastomeric material may comprise a thickness of between about 1.00 mm to about 1.50 mm, for example, about 1.20 mm. It will be appreciated that other layer thicknesses may be used within the scope of the present disclosure.

The plurality of layers may further comprise at least one layer selected from: a reinforcement material and an unreinforced elastomer material.

The uncured elastomer may comprise any suitable elastomer according to the intended purpose of the tooling bladder. For example the elastomer may comprise at least one of the following: poly-acrylic, ethylene propylene diene monomer (EPDM), fluorelastomers, nitrile, Fluorine Kautschuk Material (FKM), viton, natural rubber, silicone.

The reinforcement material may comprise at least one of carbon, glass or Kevlar. The reinforcement material may comprise a pre-impregnated matrix material (“pre-preg”), wherein the pre-prep material comprises a matrix material such as uncured resin on both or one sides, or a film of matrix material is interleaved with resin film.

The reinforced elastomer material may comprise the unreinforced elastomer material which has been reinforced with the reinforcement material. For example, the reinforced elastomer material may comprise the unreinforced elastomer material impregnated with the reinforcement material to form the reinforced elastomer material.

The method may comprise selectively reinforcing a region or regions of at least one of the first part and second part.

The selectively reinforcing may comprise providing at least one layer of reinforcement material, and/or reinforced elastomer material at the region to be reinforced. Alternatively, or additionally, the selectively reinforcing may comprise providing additional layers of composite elastomeric material at the region to be reinforced, such that the region has an increased thickness compared to an unreinforced region. The reinforced region of the first part and/or the second part may comprise radii locations. Radii locations may include corners, bends, and/or regions having complex geometries of the elastomeric tooling bladder.

The method of selectively reinforcing a region or regions of the first part and the second part allows for the degree of flexibility and/or stiffness of the elastomeric tooling bladder at the reinforced regions to be further controlled. For example, in some applications, it may be desirable to provide regions with a greater degree of stiffness compared to another region of the elastomeric tooling bladder. For example, at the location of a radii feature of the elastomeric bladder. This may be particularly advantageous for elastomeric tooling bladders having complex geometries (for example, where the elastomeric tooling bladder is for use in the manufacture of component parts having the same complex geometries). This may allow for the elastomeric tooling bladder to maintain the geometry of the radii feature, when the elastomeric tooling bladder is in use. Selectively reinforcing regions of the elastomeric tooling bladder may also allow for the elastomeric tooling bladder to provide for a greater consolidation force when in use, at the reinforced region or regions.

The bladder body may be configured to be vacuum integral. As used herein, the term vacuum integral may be defined as an ability to maintain a vacuum of a desired vacuum pressure over a defined time period. This may be specific for the intended application of the elastomeric tooling bladder. Vacuum integral may also be taken to encompass a body which when sealed under pressure is considered to be gas tight. The term “gas tight” herein refers to the body through which permeation or flow of gas is prevented (excepting de minimis leakage or permeation) under the pressure differentials across the body encountered in use. The vacuum integrity may arise, for example, from the laminated composite material. The vacuum integrity may arise, for example, from the arrangement of the plurality of layers of the laminated composite material, the material of the plurality of layers, the method of producing the elastomeric tooling bladder (for example, curing and/or consolidation processes) and/or the shape of the elastomeric tooling bladder.

The bladder body may be configured to maintain a vacuum to a maximum loss of 10 mbar or less over a defined time period, optionally a maximum loss of 5 mbar or less over the defined period. The bladder body may be configured to be vacuum integral for at least 120 thermal cycles/cures in the manufacture of a composite parts.

The provision of an elastomeric tooling bladder which is vacuum integral has several advantages for its use in the manufacture of composite parts. For example, a elastomeric tooling bladder which is configured to be vacuum integral reduces the requirement for additional manufacturing parts, such as internal vacuum bag. This may reduce manufacturing costs. An elastomeric tooling bladder which is configured to be vacuum integral may be more reliable for use during the manufacture of a composite part and/or may have improved lifetimes. For example, the elastomeric tooling bladder may have a useful life of in excess of 120 cycles within a composite part manufacturing process (i.e. thermal cycles or curing cycles).

The method may comprise forming at least one of the first part or the second part with a flange. The flange may be configured to facilitate sealing of the elastomeric tooling bladder to a closed mould for the manufacture of a composite part. Accordingly, the flange may allow for the elastomeric tooling bladder, for example when in use within the manufacture of a composite part, to be placed under a vacuum and maintain a vacuum.

The flange may comprise the reinforcement material. The flange may comprise a carbon fibre material. The flange may comprise a shape which corresponds to the shape of an end surface of the bladder body.

The method may comprise co-moulding the flange with at least one of the first part or second part during the manufacture of the elastomeric tooling bladder. The flange may be bonded to the elastomeric tooling bladder. The method may comprise forming the flange in one piece separately from the first part and the second part, and then co-moulding with the first part and the second part during the joining step. The flange may be in the form of an end frame which is configured to slot into an end of the bladder body, and wherein the co-moulding of the flange with the bladder body forms a seamless joint between the flange and the bladder body.

The method comprising co-moulding of the flange with at least one of the first part or the second part may advantageously eliminate the need for a secondary moulding or joining processes. As there may be no secondary join between the flange and the part of the bladder body, this minimises potential weak spots which could arise during use of the elastomeric tooling bladder. This may also contribute to the vacuum integrity of the elastomeric tooling bladder.

The method may comprise forming complementary mating profiles through a thickness of a wall of the first part and the second part, and wherein the joining of the first and second part at the complementary mating profiles forms a seamless joint between the first and second part.

The formation of a seamless joint between the first part and second part to form the bladder body may be desirable to prevent the formation of a potential weak spot within the structure of the elastomeric tooling bladder. Accordingly, the elastomeric tooling bladder may have improved structural integrity. The seamless joint may also be advantageous during use of the elastomeric tooling bladder for the manufacture of a composite part because there may be no variation in the surface of the elastomeric tooling bladder at the location of the joint, the elastomeric tooling bladder may not, for example, leave an imprint on a surface of the composite part.

The forming of the complementary mating profiles may comprise arranging the plurality of the layers of the laminated composite to create the desired profile. The complementary mating profiles may comprise corresponding profiles on each of the first and second parts at the end surfaces of the parts. The complementary mating profiles may comprise tapered stepped surfaces through the thickness of the wall of the part. The stepped surfaces through the thickness of the wall may be obtained by stepping each of the plurality of layers of the laminated composite material. One of the first part or second part may comprise an end wall having a protruding portion (i.e. a male end surface) which is configured to fit within a corresponding recessed portion (i.e. a female end surface) provided on the other of the first or second part, such that when the first and second part are joined to form the bladder body, there is a seamless joint between the parts.

The method may comprise forming at least one of the first part and the second part to comprise end caps for the bladder body, such the bladder body is a closed-ended elastomeric tooling bladder.

Forming the at least one of the first or second parts to comprise an end cap may comprise co-moulding an end cap to the first and/or second part during the joining process. Forming the at least one of the first or second parts to comprise an end cap may comprise forming the end cap from the plurality of layers of the laminated composite material.

The method comprising co-moulding of the ed caps with at least one of the first part or the second part may advantageously eliminate the need for a secondary moulding or joining processes. As there may be no secondary join between the end caps and the part of the bladder body, this minimises potential weak spots which could arise during use of the elastomeric tooling bladder. The structural integrity of the elastomeric tooling bladder may therefore be improved. This may also contribute to the vacuum integrity of the elastomeric tooling bladder.

At least one of the end caps may comprise an inlet port. The inlet port may be configured to be connected externally to the elastomeric bladder to, for example, atmospheric pressure and/or a source of pressurised air. In some examples, the inlet port may also be configured for connection to a vacuum bag provided inside the cavity of the elastomeric tooling bladder.

In some examples, the method may comprise locating an internal vacuum bag inside the bladder body. The method may comprise placing the internal vacuum bag inside the bladder body during the forming process such that the internal vacuum bag is integral with the bladder body.

The vacuum bag may comprise any suitable gas impermeable material or materials, formed as a single or multiple layers, with the thermal stability and mechanical strength required to withstand temperatures and pressure differentials encountered in use, typically of the order of 150 °C, 180 °C or more, depending on the matrix material and temperature cycle used. A pressure differential across the vacuum bag may be of the order of 1 atm, for example when the vacuum cavity is evacuated to assist in infusion, up to around 6-10 atm in an autoclave. The vacuum bags may comprise material such as polyacrylic, flouro elastomer, silicone, nylon or other elastomer with vacuum integrity. The vacuum bag may be a laminate, comprising more than one layer of a flexible material.

The method may comprise forming at least one of the first part or the second part with a specific geometry such that the bladder body comprises a bladder geometry, and wherein the bladder geometry is configured to match a geometry of a composite part to be manufactured.

Accordingly, the elastomeric tooling bladders of the present disclosure may comprise a bespoke geometry which is configured to correspond to the geometry of the composite part to be manufactured. For example, the elastomeric tooling bladder may be formed to comprise a leading edge which corresponds to a leading edge for an aircraft. It will be understood that any appropriate geometry or shape for the elastomeric tooling bladder is encompassed by the present disclosure.

The method may comprise forming at least one of the first part and the second part to comprise a splice extending along a length of the first part and/or the second part. The bladder body comprises the splice, and wherein the splice may be configured to permit the first part and the second part of the body to move relative to one another when the first part and the second part are joined to form the body.

Forming the elastomeric tooling bladder to comprise a splice extending along the length of the bladder body may incorporate an additional degree of flexibility into the elastomeric tooling bladder. This may be particularly useful when the elastomeric tooling bladder is to be used for the manufacture of component parts having complex geometries. This arrangement may also facilitate removal of the elastomeric tooling bladder from a composite part tooling assembly, particularly after the manufacture of the composite part.

The method may comprise closing the first mould and the second mould after layering of the plurality layers of the laminated composite material.

The method of production may comprise applying a consolidation force to the laminated composite material to consolidate the laminated composite material. The consolidation force may be applied to consolidate the plurality of layers forming the first part and the second part.

The consolidating force may be applied by placing the closed mould under a vacuum. The vacuum may be applied by the provision of an internal vacuum bag and an external vacuum bag which may be fluidly connected and arranged to form a cavity from which air can be removed, forming a vacuum.

The joining of the first part and the second part may comprise curing of the laminated composite material. The curing may be achieved by the application of at least one of heat or pressure. The curing temperature and pressure will correspond to the curing temperature and pressure of the elastomeric material. For example, the method may comprise curing of the laminated composite material at a temperature of at about 160 °C to about 205 °C. For example, the method may comprise curing of the laminated composite material at a pressure of up to about 6 bar. In some examples, the curing may be performed under vacuum pressure only. This may reduce production costs for the elastomeric tooling bladder.

The method may comprise removing the bladder body from the first and second mould, after curing of the bladder body.

The method may comprise applying a coating layer to an outer surface of the elastomeric tooling bladder. For example, the coating layer may comprise at least one of a resin distribution material, or a polymer film layer.

The resin distribution media may comprise for example, an expanded nylon material, an expanded tetrafluoroethylene layer (ETFE) or Fluorinatedethylenepropylene (FEP) film layer. The resin distribution material may be in the form of a mesh material.

The polymer film layer may comprise, for example, an expanded tetrafluoroethylene layer (ETFE) or Fluorinatedethylenepropylene (FEP) film layer.

In some examples, the polymer film layer may applied to the first mould and the second mould, prior to the forming of the first part and the second part, and as such, the polymer film layer may comprise an outer surface of the elastomeric tooling bladder.

The polymer film layer may be treated on one side to permit bonding to the laminated composite material, and release of the elastomeric tooling bladder when used to form a composite part. The treated side of the polymer film layer may comprise etching

The coating layer may facilitate improved distribution of resin over an outer surface of the elastomeric tooling bladder when the elastomeric tooling bladder is used in the manufacture of a composite part. The coating layer may facilitate ease of removal of the elastomeric tooling bladder from a component part tooling assembly after the manufacture of a composite part.

In some examples, the coating layer may provided as an inner most layer of the first or second part on the moulds. Accordingly, the coating layer may form an inner surface of the elastomeric tooling bladder. This may prevent resin ingress into the bladder during manufacture of a composite part.

According to another aspect of the present disclosure, there is provided an elastomeric tooling bladder for use in the manufacture of a composite part, the elastomeric tooling bladder comprising: a bladder body defining a cavity, wherein the bladder body is formed from a laminated composite material comprising a plurality of layers, and wherein at least one layer comprises a reinforced elastomer material; and wherein the bladder body is configured to accommodate thermal expansion and contraction.

The elastomeric tooling bladder of the second aspect corresponds to the elastomeric tooling bladder formed according to the method of manufacture of the first aspect.

The bladder body may be configured to have a desired flexibility. The desired flexibility may be achieved by at least one of the following: the selection of the plurality of layer materials, the number of the plurality of layers, the order of the plurality of layers, and/or the location of the layers forming the body.

The bladder body may comprise at least one region which has been selectively reinforced with a reinforcement to material.

The bladder body may be configured to be vacuum integral. The elastomeric tooling bladder may be configured to be vacuum integral.

The bladder body may be configured to maintain vacuum to a maximum loss of 10 mbar or less over a defined time period, optionally a maximum loss of 5 mbar or less over the defined period.

The bladder body may be formed from a first part and a second part. The first part and the second part may comprise complementary mating profiles which can be joined to form a seamless joint between the first part and the second part.

The bladder body may comprises a flange which has been co-moulded with bladder body. The flange may be configured to facilitate sealing of the elastomeric tooling bladder to a closed mould for the manufacture of a composite part.

The bladder body may comprise a splice extending along a length of the bladder body. The splice may be configured to permit a first part and a second part of the bladder body to move relative to one another.

The elastomeric tooling bladder may further comprise a coating layer on an external surface of the bladder body. The coating layer may be at least one of: a resin distribution media, or a polymer film layer.

As discussed above with reference to the methods of manufacture, The elastomeric tooling bladders of the present disclosure comprise at least one layer of a reinforced elastomeric material and as such, may be considered to be semi-flexible. However, unlike known elastomeric tooling bladders, the degree of flexibility of the elastomeric tooling bladders of the present disclosure can be carefully selected to impart a desired flexibility required for the intended application of the elastomeric tooling bladder. For example, the elastomeric tooling bladders of the present disclosure are intended to be used a “soft tooling” in the manufacture of composite parts. The elastomeric bladders are configured to accommodate thermal expansion and contraction which may occur during the manufacture of a composite part, whilst maintaining geometrical integrity (i.e. overall shape) by virtue of the reinforced elastomer layer.

Elastomeric tooling bladders of the present disclosure may be configured to act as an ‘expansion joint’ between tightly controlled hard tooling and may alleviate tolerance stack-ups. The elastomeric tooling bladders of the present disclosure may also aid in air extraction and resin flow distribution across a component part during manufacture of the component part. This may increase wet out whilst reducing the infusion time for the manufacture of a component part.

The elastomeric tooling bladders according the present disclosure are configured to enact a consolidation force on a component within a component tooling assembly by way of a pressure differential. The consolidation force may be generated in atmospheric conditions or in an autoclave. The elastomeric tooling bladders may be configured to perform a consolidation pressure at, for example, at about 20 °C to about 205 °C. The elastomeric tooling bladders of the present disclosure may be configured to be autoclave capable, i.e. able to withstand temperatures of about 180 °C without degradation.

The term “semi-flexible” herein refers to a degree to flexibility that allows the elastomeric tooling bladder to deflect to some degree to accommodate thermal expansion and contraction of the elastomeric tooling bladder and/or adjacent components, under the conditions encountered in use (typically over a temperature range from around ambient temperature to around 200-210 Celsius depending on manufacturing conditions), but having sufficient rigidity to maintain the general shape and configuration of the elastomeric tooling bladder, under its own weight. That is to say, a flexible tooling bladder may in use be draped over and/or peeled from a layup or part as the case may be, whereas a semi-flexible elastomeric bladder can be positioned or removed as a whole. In comparison to a hard tooling surface or hard tooling, the degree of flexibility afforded by a semi-flexible elastomeric tooling bladder eases separation of parts from the mould (that might otherwise be retained by suction against a hard surface such as Invar). In turn, the risk of surface damage upon release or separation of composite parts is reduced.

According to another aspect of the present disclosure, there is provided a method of using an elastomeric bladder according to the first aspect to manufacture a composite part.

### BRIEF DESCRIPTION OF THE FIGURES

The disclosure will now be described, by way of example only, with reference to the following Figures in which:

FIG. 1 is a sectional illustration of a typical closed mould application as known in the art.

FIG. 2 is a sectional illustration of a closed mould application utilising bladders according to the present disclosure in combination with hard tooling.

FIG. 3 is a sectional illustration of another closed mould application utilising bladders according to the present disclosure in combination with hard tooling.

FIGS. 4a to 4e show a schematic illustration of the manufacture of a component part for an aircraft using bladders according to the present disclosure.

FIGS. 5a to 5d show a schematic illustration of the method for manufacturing a bladder according to the present disclosure.

FIGS. 6a and 6b show a schematic illustration of the method for manufacturing another bladder according to the present disclosure.

FIGS. 7a and 7b show sealing options for bladders according to the present disclosure.

FIG. 8a shows an illustration of a bladder having a closed end according to the present disclosure; and FIG. 8b shows an illustration of an internal tubing within the bladder of FIG. 9a.

### DETAILED DESCRIPTION

The present disclosure relates to elastomeric tooling bladders for use in the manufacture of composite parts. The composite parts may include body parts in the aerospace and other related industries. In particular, the elastomeric tooling bladders of the present disclosure are configured to be vacuum integral and are designed to enact a consolidation force (either atmospheric or autoclave) on a component within a component tooling assembly by way of a pressure differential.

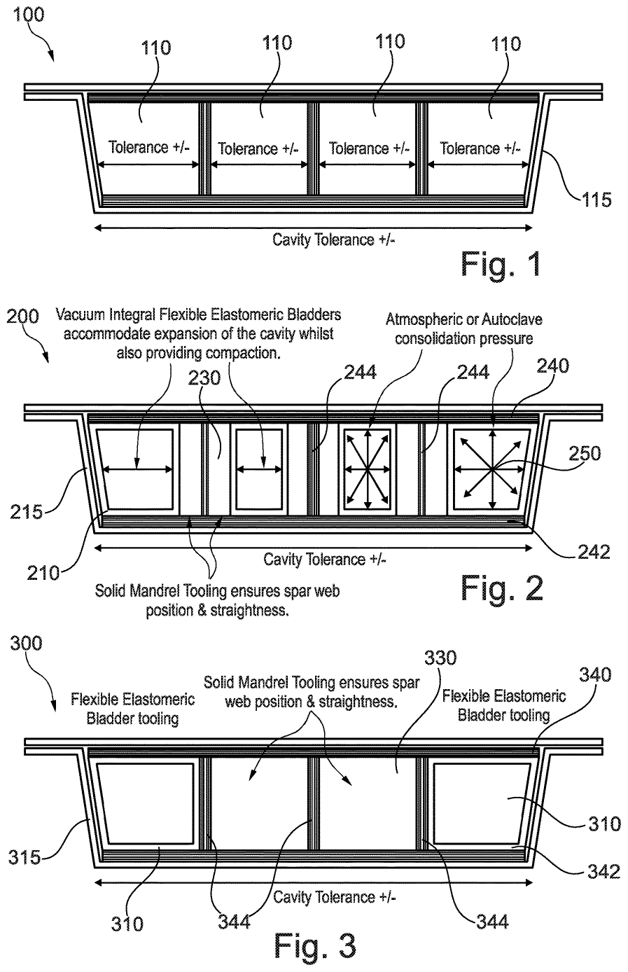

FIG. 2 is an example moulding application 200 utilising an elastomeric bladder tooling according to the present disclosure. A solid outer mould 215 is provided internally with a plurality of elastomeric tooling bladders 210 and solid tooling mandrels 230. In use, the elastomeric tooling bladders 210 are semi-flexible and can accommodate expansion of the cavity of the outer mould 215, whilst also providing compaction. The solid tooling mandrels 230 act to ensure spar web 244 position and straightness. The flexible tooling bladders 210 are vacuum integral and therefore, work to create a consolidation pressure on either the solid tooling mandrels 230 (thus consolidating spar webs 244) or on upper skin 240 and lower skin 242 of the composite part being manufactured. The flexible tooling bladders 210 are particularly useful for controlling the formation of less tolerance critical areas such as the skin 240, 242 of the composite part. The elastomeric properties of the tooling bladder works to alleviate the complex tolerance stack-ups found in fully metallic tooled solutions, such as that shown in FIG. 1.

FIG. 3 show an alternative moulding application 300 with an alternative arrangement of flexible tooling bladders 310 and solid tooling mandrels 330 within solid outer mould 315 cavity. It will be appreciated that different arrangements of flexible tooling bladders and solid tooling mandrels are contemplated by the present disclosure as required according to the composite part manufacturing process, however, the elastomeric tooling bladders of the present disclosure will provide the same or similar benefits across all possible arrangements. In FIG. 3, the spar webs 344 are being controlled (at least on one side) in its position and straightness by fixed solid tooling 330. The spar faces 340, 342 where tolerance is not of critical importance, can be formed directly by the flexible bladder tooling 310. In some applications, the outer mould 315 may be a cast of polyurethane.

The flexible tooling bladders of the present disclosure can be used to control areas between spar locations as shown in FIGS. 2 and 3. The flexible tooling bladders can provide a consolidation pressure, shown by arrows 250 in FIG. 2 (atmospheric or autoclave) either directly on the component part or on the mandrel tooling. The flexible tooling bladders of the present disclosure are configured to act as an “expansion joint” between the solid mandrels and alleviate tolerance stack ups. The flexible tooling bladders of the present disclosure can be configured to permit “over the surface” resin flow either via the flexibility of the bladder itself or with the aid of resin distribution media which can be provided on an outer surface of the bladder.

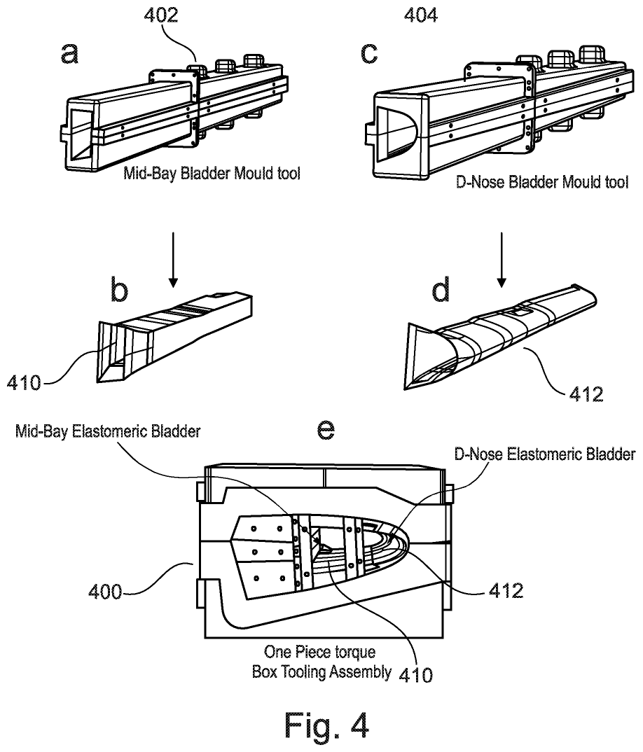

The flexible tooling bladders of the present disclosure are manufactured in a mould tool having the desired shape of the bladder. FIG. 4a shows an exemplary bladder mould tool 402 for a mid-bay shaped elastomeric bladder 410. FIG. 4c shows another exemplary bladder mould tool 404 for a tooling bladder comprising a leading edges, for example, a D-nose shaped elastomeric bladder 412. The mid-bay shaped elastomeric bladder 410 and the leading edge tooling bladder 412 can be positioned in, for example, a one-piece torque box tooling 400 for manufacture of a one-piece torque box (FIG. 4e).

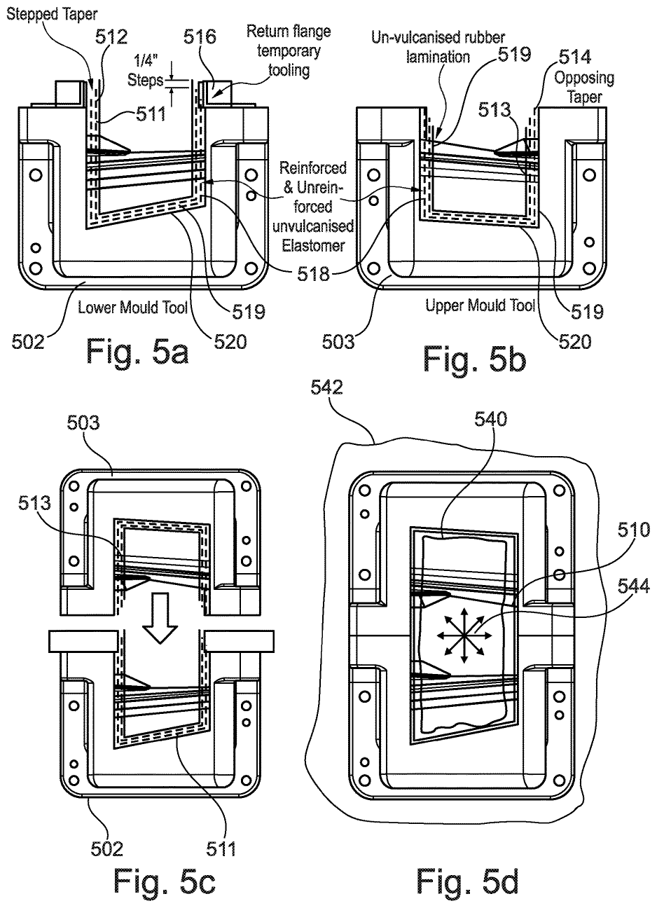

To manufacture an elastomeric tooling bladder according to the present disclosure, a mould tool such as those shown in FIGS. 4a and 4c must first be created. An upper mould tool 503 and a lower mould tool 502 is provided as shown in FIGS. 5a and 5b. The use of the term upper and lower should not be construed as limiting on the particular geometry and orientation of the moulds and resulting tooling bladders, the terms are used as exemplary only. Each mould tool 502, 503 comprises a shaped moulding surface 519, for example in the form of a cavity of recess and upon which layers of reinforcement material, reinforced uncured elastomer and uncured elastomer can be layered upon, and laminated to form a first part 511 and a second part 513 which are joined to form the elastomeric tooling bladder 510. The elastomeric tooling bladder 510 is an open ended elastomeric tooling bladder having a bladder body formed from laminated composite material and which defines a cavity.

The uncured elastomer may comprise any suitable elastomer according to the intended purpose of the tooling bladder. For example the elastomer may comprise at least one of the following: poly-acrylic, ethylene propylene diene monomer (EPDM), fluorelastomers, nitrile, Fluorine Kautschuk Material (FKM), viton, natural rubber, silicone. The reinforcement material may comprise at least one of carbon, glass or Kevlar. The reinforcement material may comprise a pre-impregnated matrix material (“pre-preg”), wherein the pre-prep material comprises a matrix material such as uncured resin on both or one sides, or a film of matrix material is interleaved with resin film.

In the present example, an optional first layer 520 of carbon fibre pre-preg is deposited on the moulding surface 519 of the moulds 502, 503. The first layer 520 of carbon fibre pre-preg can be deposited either in specific areas of the moulding surface 519 (a “partial layer), or over the entire moulding surface 519 (a “full layer”). In this example, the carbon fibre pre-preg layer 520 is a single layer applied uniformly over the full moulding surface.

The use of carbon fibre pre-preg as a reinforcing layer has several advantages. When used in the radii of the elastomeric tooling bladder, it provides for excellent component quality and definition. When used to form the entire surface of the elastomeric tooling bladder, it provides an extremely robust tool which is compatible with all forms of release agents, such as semi-permeable release agents.

The first layer 520 deposited on at least one of the upper or lower moulds 502, 503 may comprise a pre-preg material which is tacky may facilitate mould rotation and closing. This can also provide for increased consolidation (particularly, at radii features) of the laminate composite material, and provides a desired surface finish.

The first layer 520 to be deposited on the moulds can be a polymer film layer. For example, an ETFE or FEP film layer. The film layer may be treated on one side to permit bonding and release of the tooling bladder when used to form a composite part. Alternatively, the bladder 510 may be coated with a polymer film layer or layer of resin transfer medium after forming of the bladder 510.

The material of the plurality of layers, the number of the plurality of layers, the order of layers, and the thickness of each layer of the laminated composite material can be selected to impart a desired flexibility and stiffness to the bladder. These selections also contribute to providing an elastomeric tooling bladder which is vacuum integral. Accordingly, the lamination can be tailored for the intended use of the tooling bladder.

The lower mould 502 is provided with a removable return flange 516. The removable return flange permits the first part 511 of the bladder to extend beyond the split line of the mould 502. It will be appreciated that the removable return flange could alternatively be provided on the upper mould 503.

The removable return flange 516 creates an extension surface of the mould 502 which allows the manufacture of a tapered edge profile 512 through an end wall on the first part 511. This tapered edge 512 can be formed by stepping each layer of the lamination. An opposing tapered edge 514 is formed on the upper portion 513 of the bladder. The tapered edges 512, 514 may be provided with a 0.25 inch step between layers. Thus, the first part 511 and the second part 513 are formed with complementary mating profiles which can be joined to form a seamless joint between the first part 511 and the second part 512.

The manufacturing method comprises closing the lower mould 502 and the upper mould 503 to join the first part 511 and the second part 512. The removable return flange 516 is removed to permit the lower mould 502 and the upper mould 503 to be united as shown in FIG. 5c. The tapered edges 514 when joined form a matched overlap which forms a join interface. The join interface can be bonded during the curing process to form the elastomeric tooling bladder 510, whilst maintaining a constant material thickness across the wall of the elastomeric tooling bladder body 510.

Once the lower mould 502 and the upper mould 503 are joined, a vacuum internal tube or bag 540 is installed in the bladder cavity 544. An external vacuum bag 542 is placed around the outside of the joined moulds as shown in FIG. 5d. The internal vacuum bag 540 and the external vacuum bag are connected forming a cavity from which air is extracted. The internal vacuum tube 540 applies a consolidation pressure on the laminated composite material by means of an atmospheric pressure differential (i.e. 1 atm). The consolidation pressure compresses the plurality of layers to form the laminated composite material.

The vacuumed mould assembly of FIG. 5d is then autoclaved or placed into an oven, where the bladder 510 is cured according to the curing requirements of the elastomeric material of the laminated composite material. In some example, the bladder 510 may be cured out-of-autoclave, i.e. under vacuum pressure only.

The vacuum bags may comprise any suitable gas impermeable material or materials, formed as a single or multiple layers, with the thermal stability and mechanical strength required to withstand temperatures and pressure differentials encountered in use, typically of the order of 150 °C, 180 °C or more, depending on the matrix material and temperature cycle used. A pressure differential across the vacuum bag may be of the order of 1 atm, for example when the vacuum cavity is evacuated to assist in infusion, up to around 6-10 atm in an autoclave. The vacuum bags may comprise material such as polyacrylic, flouro elastomer, silicone, nylon or other elastomer with vacuum integrity. The vacuum bag may be a laminate, comprising more than one layer of a flexible material.

The resulting bladder 510 is vacuum integral and is configured to maintain vacuum integrity to a maximum loss of 10 mbar or less over a defined time period, optionally a maximum loss of 5 mbar or less over the defined period. Additionally, the bladder 510 can feasibly have a life/longevity shown to be 120cycles+.

The skilled person will appreciate that the moulding tools used to manufacture the tooling bladders of the present disclosure may comprise any desired shape as required to provide the bladder with a desired shape for its intended application.

In some examples, the tooling bladder may require extra flexibility. This extra flexibility may allow the tooling bladder to expand further to provide consolidation on the component of the composite part being manufactured, or to permit the bladder to contract further facilitating extraction of the bladder from a composite part tooling assembly.

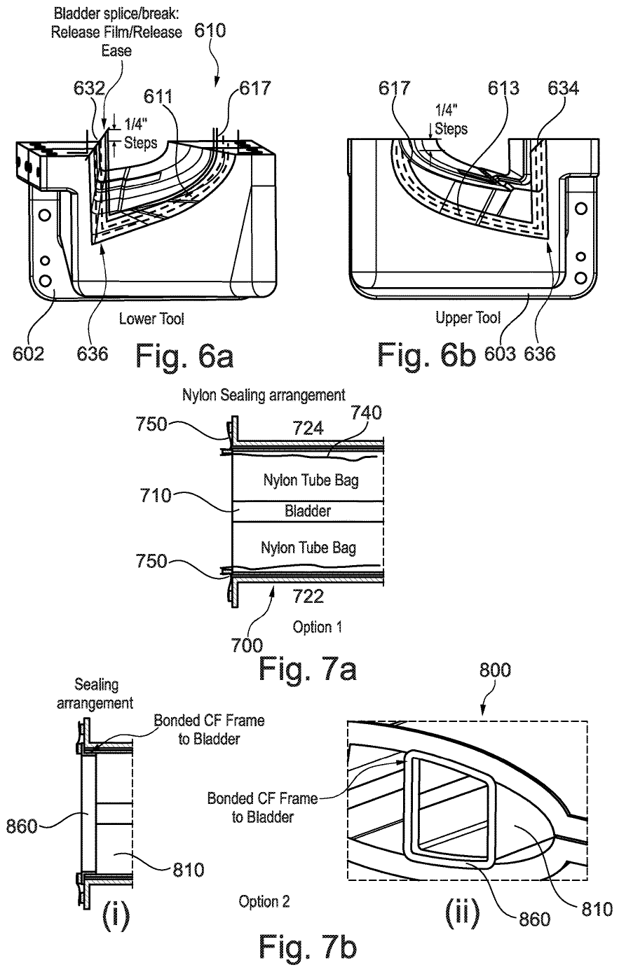

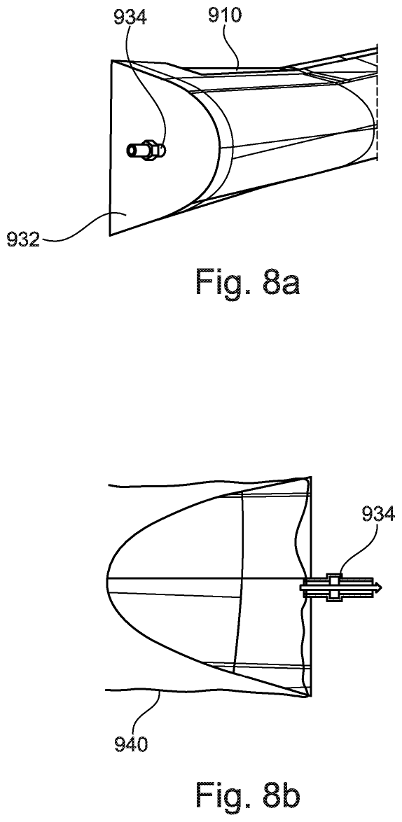

The tooling bladder 610 shown in FIGS. 6a and 6b is an examples of an elastomeric tooling bladder provided with said extra flexibility. The tooling bladder 610 is formed in two moulds similarly to the process outlined for FIGS. 5a to 5d. Additionally, the first part 611 and second part 613 of the bladder 610 are provided with a splice 634 extending along the length of each part. When the first part 611 and second part 613 are joined (in the same method as outlined with respect to FIGS. 5c and 5d, and the corresponding description), the resulting tooling bladder 610 comprises the splice 634 along a length of the body of the bladder 610. The splice 634 permits the first part 511 and the second part 613 to expand when the bladder 610 is used during component manufacture to exert a consolidation force on the component part, and also to collapse inwards after the component manufacture is completed. This allows for the bladder 610 to be extracted, and is particularly useful when the composite part comprises complex geometries. The elastomeric tooling bladder 610 comprises a tight corner 636 and therefore, careful forming of the elastomeric tooling bladder 610 at this corner 636 to avoid bridging and maintain the defined shape of the elastomeric tooling bladder 610.

The tooling bladder 610 is used in a composite tooling assembly in conjunction with a vacuum assembly, comprising an internal vacuum bag to provide the tooling bladder 610 with vacuum integrity. In order to prevent resin ingress into bladder 610 during the manufacture of a composite part, the inside surface of the tooling bladder 610 is coated with a thin film 617 of Fluorinatedethylenepropylene (FEP). The film 617 is treated on one side to facilitate bonding to the elastomer material of the tooling bladder during the curing process and to provide release on the other side of the film.

The tooling bladders of the present disclosure can be inherently vacuum integral, for example, by virtue of the material selection and geometry of the elastomeric tooling bladder. Alternatively, or additionally, the tooling bladders can be provided with vacuum integrity. As shown in FIG. 7a, the tooling bladder 710 may be provided with an internal vacuum bag 740 connected to an external vacuum bag 742 thereby providing a cavity from which air can be removed. As show in FIG. 7b, the tooling bladder 810 can be provided with a flange 860 formed from, for example, carbon fibre. The flange 810 may be formed as a one piece end frame which is configured to slot into an end portion of the bladder body (see, FIG. 7b (i)). The flange 860 is co-moulded to the elastomeric tooling bladder parts and forms a return flange which is configured for connection to a composite part tooling sealing arrangement.

The elastomeric tooling bladders of the present disclosure can be manufactured as closed-ended bladders, for example as shown in FIGS. 9a and 9b. The tooling bladder 910 is manufactured as outlined above with respect to FIGS. 5a to 5d, however, the internal vacuum bag or tube 940 (used to consolidate the laminate composite material) is positioned internally during the manufacturing process. In this example, the moulds are laminated with the laminated composite material, including closed-end caps 932, and the internal vacuum bag 940 is placed into the mould prior to the joining steps (of FIGS. 5c and 5d). At least one of the closed end caps 932 is provided with an inlet port 934 which is configured to be connected to the internal vacuum bag or tube 940 and to connect externally to either atmospheric pressure or pressurised air. The elastomeric tooling bladder 910 is them formed from the two parts according to the methods outlined above.

It will be clear to those of skill in the art that the above described embodiments are merely exemplary, and that various modifications and improvements thereto may be made without departing from the embodiments described. For example, the tooling bladder and the mouldings may be a range of shapes and sizes. The tooling bladder and the mouldings may be a range of shapes and sizes. may also be made a range of suitable materials. Likewise, where methods are performed out of autoclave, the methods may also be applicable to in-autoclave fabrication-such as where similar benefits may also be achieved.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims, including with equivalence as appropriate.

1. A method of manufacturing an elastomeric tooling bladder, wherein the method comprises:
forming a first part comprising a laminated composite material in a first mould,
forming a second part comprising a laminated material structure in a second mould,
wherein the laminated composite material comprises a plurality of layers, and wherein at least one layer comprises a reinforced elastomer material;
joining the first part and the second part to form a bladder body defining a cavity, wherein the bladder body is configured to accommodate thermal expansion and contraction.

2. The method of claim 1, comprising selecting a desired flexibility for the bladder body, and wherein the forming of the first part and second part comprises selecting the material for the plurality of layers, selecting a number of the layers, and layering the plurality of layers in a desired order, selecting a thickness for a layer, and/or at a desired location to impart the desired flexibility to the body.

3. The method of claim 1, comprising selectively reinforcing a region or regions of at least one of the first part and second part.

4. The method of any preceding claim, wherein the bladder body is configured to be vacuum integral, and wherein bladder body is configured to maintain a vacuum to a maximum loss of 10 mbar or less over a defined time period, optionally a maximum loss of 5 mbar or less over the defined period.

5. (canceled)

6. The method claim 1, comprising forming at least one of the first part or the second part with a flange configured to facilitate sealing of the elastomeric tooling bladder to a closed mould for the manufacture of a composite part.

7. The method of claim 6, wherein the method comprises co-moulding the flange with the at least of the first part or second part.

8. The method of claim 1, comprising forming complementary mating profiles through a thickness of the wall of the first part and the second part, and wherein the joining of the first and second part at the complementary mating profiles forms a seamless joint between the first part and second part.

9. The method of claim 8, wherein the complementary mating profiles comprise tapered stepped surfaces, and wherein the stepped surfaces are obtained by stepping each of the plurality of layers of the laminate composite material.

10. The method of claim 1, comprising forming at least one of the first part and the second part to comprise end caps for the bladder body, such the bladder body is a closed-ended elastomeric bladder.

11. (canceled)

12. The method of claim 1 comprising forming at least one of the first part or the second part with a specific geometry such that the bladder body comprises a bladder geometry, and wherein the bladder geometry is configured to match a geometry of a composite part to be manufactured.

13. The method of claim 1, comprising forming at least one of the first part and the second part to comprise a splice extending along a length of the first part and/or the second part, and wherein the bladder body comprises the splice, and wherein the splice is configured to permit the first part and the second part of the bladder body to move relative to one another when the first part and the second part are joined to form the bladder body.

14. The method of claim 1, wherein the joining of the first part and the second part comprises curing of the laminated composite material, and wherein the curing is achieved by the application of at least one of heat or pressure.

15. An elastomeric tooling bladder for use in the manufacture of a composite part, the elastomeric tooling bladder comprising:
a bladder body defining a cavity, wherein the bladder body is formed from a laminated composite material comprising a plurality of layers, and wherein at least one layer comprises a reinforced elastomer material; and
wherein the bladder body is configured to accommodate thermal expansion and contraction.

16. The elastomeric tooling bladder of claim 15, wherein the bladder body is configured to have a desired flexibility, and wherein the desired flexibility is achieved by at least one of the following: the selection of the plurality of layer materials, the number of the plurality of layers, the order of the plurality of layers, and/or the location of the layers forming the body.

17. The elastomeric tooling bladder of claim 15, wherein the bladder body comprises at least one region which has been selectively reinforced with a reinforcement to material.

18. (canceled)

19. The elastomeric tooling bladder of claim 15, wherein the bladder body is configured to maintain a vacuum to a maximum loss of 10 mbar or less over a defined time period, optionally a maximum loss of 5 mbar or less over the defined period.

20. The elastomeric tooling bladder of claim 15, wherein the bladder body is formed from a first part and a second part, and wherein the first part and the second part comprise complementary mating profiles which can be joined to form a seamless joint between the first part and the second part.

21. The elastomeric tooling bladder of claim 15, wherein the bladder body comprises a flange which has been co-moulded with bladder body, and wherein the flange is configured to facilitate sealing of the elastomeric tooling bladder to a closed mould for the manufacture of a composite part.

22. The elastomeric tooling bladder of claim 15, wherein the bladder body comprises a splice extending along a length of the bladder body, and wherein the splice is configured to permit a first part and a second part of the bladder body to move relative to one another.

23. The elastomeric tooling bladder of claim 15, further comprising a coating layer on an external surface of the bladder body, wherein the coating layer is at least one of: a resin distribution media, or a polymer film layer.
